(19) United States
(12) Patent Application Publication
(10) Pub. No.: US 2014/0311840 A1
(43) Pub. Date: Oct. 23, 2014

(54) Hydrodynamic Retarder and Method for Actuating Same

(71) Applicant: Voith Patent GmbH, Heidenheim (DE)

(72) Inventors: Achim Menne, Crailsheim (DE); Tilman Huth, Satteldorf (DE); Dieter Laukemann, Crailsheim (DE); Werner Koch, Deggingen (DE); Werner Klement, Heidenheim (DE); Martin Becke, Ulm (DE)

(73) Assignee: Voith Patent GmbH, Heidenheim (DE)

(21) Appl. No.: 14/359,052

(22) PCT Filed: Dec. 7, 2012
(86) PCT No.: PCT/EP2012/074787

§ 371 Date: May 16, 2014

(30) Foreign Application Priority Data
Dec. 9, 2011 (DE) 10 2011 120 620.9

(51) Int. Cl. B60T 10/02; F16D 61/00; F16D 57/00

(52) U.S. Cl. CPC B60T 10/02; F16D 57/00; F16D 61/00
USPC 188/290

(57) ABSTRACT

The invention relates to a hydrodynamic retarder comprising a rotor that revolves in a decelerating mode and a counter-rotating twin rotor or a stationary stator which jointly from a working chamber that is or can be filled with a working medium. The rotor can be driven using driving power via a drive train in order to decelerate the drive train. The invention is characterized in that an energy storage device is associated with or integrated into the retarder, said energy storage device comprising a mechanical energy store, pressure accumulator or kinetic energy store as well as an acceleration mechanism that is connected to the rotor, said acceleration mechanism being linked to the energy store and the rotor or being integrated into the rotor in order to convert energy stored in the energy store into an angular acceleration of the rotor.

The present invention concerns a hydrodynamic retarder and a method for actuating the same, in detail according to the preamble of the independent claims.

Hydrodynamic retarders have long been used as wear-free continuous brakes in drive trains, in particular in motor vehicle drive trains, the latter for example in lorries. Thereby, the rotor of the hydrodynamic retarder, which forms with an associated stator a toroidal working chamber which is filled with working medium or can be filled with working medium, is driven by the drive train and thereby brakes the drive train, in particular the vehicle, because the braking torque is transmitted via a hydrodynamic circuit of the working medium in the working chamber from the rotor to the stator. A counter-rotor driven in reverse direction to the rotor can be provided instead of a stator to form a so-called counter-rotating retarder.

The stronger the rotor and with the usual consequence that a rotor shaft, which carries the rotor and is in drive connection with the drive train, is delayed, the greater the braking power generated by the retarder. The development of hydrodynamic retarders is thus specialised to achieve the greatest possible delay of the rotor of the hydrodynamic retarder in terms of high braking powers.

The shortcoming with the known forms of embodiment lies in that in the non-braking mode of the hydrodynamic retarder said retarder often generates so-called no-load losses which undesirably decelerate the drive train. If a separating clutch is provided for mechanical decoupling of the rotor of the hydrodynamic retarder in the non-braking mode, the no-load losses may admittedly be minimised but the coupling of the rotor of the hydrodynamic retarder is problematic, when changing over from the non-braking mode to the braking mode, due to the switching energy to be generated by the separating clutch. Finally, there are use cases in which the braking torque of the hydrodynamic retarder must be predictable with accuracy, which is not yet guaranteed sufficiently in the known forms of embodiment without considerable additional costs.

The object of the present invention is consequently to provide a hydrodynamic retarder and a method for actuating the same, which mitigate or avoid the problems aforementioned.

The object of the invention is satisfied with a hydrodynamic retarder exhibiting the features of claim 1 and a method exhibiting the features of claim 9. Advantageous and particularly appropriate embodiments of the invention are disclosed in the dependent claims.

A hydrodynamic retarder according to the invention comprises as previously a rotor revolving in a braking mode and a counter-rotor driven or revolving in opposite direction thereto, to form a counter-rotating retarder, or a stationary stator. Rotor and stator or rotor and counter-rotor form together a working chamber which is always filled with a working medium or can be filled with a working medium. The rotor can be driven with drive power via a drive train for decelerating the drive train.

According to the invention, an energy storage device is associated with the hydrodynamic retarder or integrated therein, containing a mechanical energy storage device, for example a spring mechanism, an accumulator or a kinetic energy storage device, and an acceleration device connected to the rotor. The acceleration device is driven with energy from the energy store for converting said energy into rotational energy and generates thereby an angular acceleration of the rotor of the hydrodynamic retarder.

The acceleration device can be designed for instance as a hydraulic machine or as a pneumatic machine, in combination with an energy store as an accumulator, in particular an air pressure storage device, a gas pressure storage device or a hydraulic storage device. In particular, a piston engine or a turbine, for example a Pelton turbine, an air motor, a gas motor, an air turbine, a gas pressure-operated turbine or gas turbine can by way of example.

In an embodiment according to the invention, the acceleration machine is designed so as to be operated reversibly for feeding energy into the energy storage device, in particular as a piston engine or a flow compressor. Alternately or additionally, the energy storage device can include a charging device, which converts energy, in particular of the rotor of the hydrodynamic machine and/or pressure energy of the working medium of the hydrodynamic retarder, into energy of the energy storage device, in particular into pressure energy, and conveys it to the energy storage device. According to an embodiment, the charging device operates exclusively in the braking mode of the hydrodynamic retarder and conveys exclusively energy of the hydrodynamic retarder to the energy storage device.

An embodiment according to the invention provides sets forth that the energy storage device is designed as a flywheel which can be selectively connected and brought in driving connection with the rotor of the hydrodynamic retarder, by means of a coupling, in particular a magnetic coupling. It is thus for example possible always in the braking mode or at selected points in time of the braking mode of the hydrodynamic retarder or also independently of the braking mode of the hydrodynamic retarder, to use the rotational energy of the hydrodynamic retarder or of another revolving masse in the drive train, into which the hydrodynamic retarder is mounted, for accelerating the flywheel, and be employed at a later point in time for accelerating the rotor of the hydrodynamic retarder.

Another form of embodiment, which can be provided also in addition, sets forth that the energy storage device is designed as a pressure storage device or a spring mechanism and the acceleration device presents a device for converting a translation into a rotation, by means of which the energy of the pressure storage device is converted into driving energy for the rotor of the hydrodynamic retarder. The conversion device can include for instance a piston thread rod which carries the rotor of the hydrodynamic retarder and causes a rotational movement of the rotor when said rod is displaced, or a piston gear rack which meshes accordingly with a gear which is drive connection with the rotor or with a gear carried on said rotor and thereby causes a rotation of the rotor when said gear is displaced.

The hydrodynamic retarder or the power branch of the drive train, in which the hydrodynamic retarder is arranged, for instance an auxiliary power take-off of a motor vehicle transmission or drive motor of the drive train, can present a mechanical separating clutch for mechanical decoupling of the rotor of the hydrodynamic retarder and the acceleration device can be arranged for automatic synchronisation of the separating clutch by acceleration of the rotor of the hydrodynamic retarder when closing the separating clutch. By automatic is meant that the actuation of the acceleration device is performed by the retarder or the separating clutch itself, in particular by appropriate mechanical operative connections. In addition to the automatic acceleration, an acceleration device controlled by a control device can be considered for accelerating the rotor. By way of example, the retarder control device, which controls the retarder or its braking torque, can be employed for controlling the synchronisation of the separating clutch by means of the acceleration device according to the invention. Complete synchronisation of the separating clutch as well as a partial synchronisation of the separating clutch by means of the acceleration device can be considered.

By separating clutch should be understood here every component which in a first operating mode creates a power transmission, in particular a mechanical power transmission and in a second operating mode interrupts said transmission, consequently for instance synchronous elements, friction clutches and others.

As represented, a form of embodiment of the invention sets forth that the energy storage device with the acceleration device is used for synchronising a separating clutch of a hydrodynamic retarder which can be disengaged mechanically In order to reduce thereby the switching work of the separating clutch. It can also be considered as an alternative to accelerate the rotor of a hydrodynamic retarder which cannot be decoupled, for example to adjust a required braking torque particularly exactly using more or less strong driving of the rotor. Finally, the energy storage device according to the invention can be used for reducing the no-load losses in the non-braking mode by driving the rotor of the hydrodynamic retarder.

A method according to the invention for actuating a hydrodynamic retarder according to the invention sets forth that the rotor is accelerated with energy from the energy store by means of the acceleration device, during the changeover from a non-braking mode of the hydrodynamic retarder to the braking mode of the hydrodynamic retarder, in the braking mode of the hydrodynamic retarder or in the non-braking mode of the hydrodynamic retarder. In particular, the acceleration can be considered when changing over from the non-braking mode to the braking mode, if a separating clutch is provided for mechanical decoupling of the rotor.

In particular, it can be set forth in the latter case that the energy storage device is employed exclusively for accelerating the rotor of the retarder when changing over from the non-braking mode to the braking mode and apart from said change-over, i.e. the rotor of the hydrodynamic retarder is driven in the braking mode exclusively using the driving power from the drive train, which should be decelerated with the hydrodynamic retarder, by way of example motor vehicle drive train.

It can be further provided that the energy store is charged in the braking mode or exclusively in the braking mode of the hydrodynamic retarder by means of kinetic energy of the retarder or pressure energy of the retarder, which in particular is provided or converted by the acceleration device or the charging device.

The invention will now be described by way of example using embodiments and the figures.

The figures are as follows:

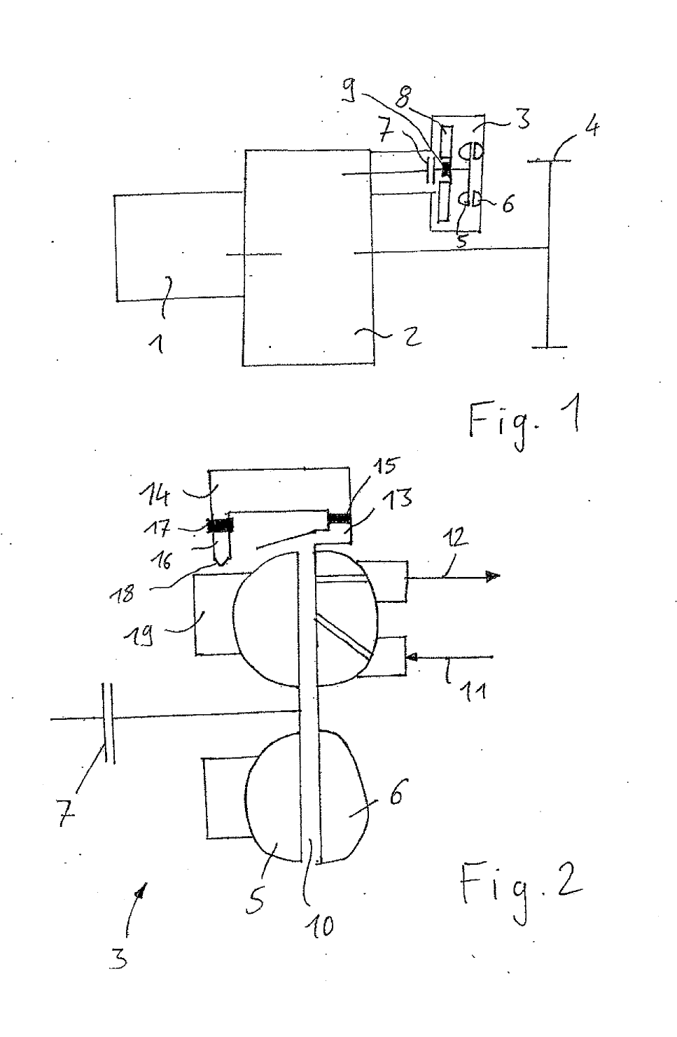

FIG. 1 shows a hydrodynamic retarder connected to a vehicle transmission on its secondary side with a flywheel store;

FIG. 2 shows a form of embodiment of a hydrodynamic retarder with a pressure storage device.

FIG. 1 represents a motor vehicle drive train, with a drive motor 1, a transmission 2 and a hydrodynamic retarder 3 connected to the transmission 2 on its secondary side. The drive motor 1 drives drive wheels 4 of the motor vehicle via the transmission 2.

The hydrodynamic retarder 3 includes a rotor 5 and a stator 6, which together form a toroidal working chamber. The rotor 5 can be disengaged mechanically from the drive train by means of a separating clutch 7.

Moreover, a flywheel 8 is associated with the rotor 5, a flywheel which can be brought in driving connection by means of a coupling, in particular a magnetic coupling 9, selectively with the rotor 5 or can be decoupled therefrom.

It is possible to do so to transmit a driving power from the rotor 5 to the flywheel 8 in appropriate operating modes, for instance during the braking mode of the hydrodynamic retarder 3, and every time it should be advantageous to accelerate the rotor 5, to transmit the driving power from the flywheel 8 to the rotor 5, by way of example for synchronising the separating clutch 7 when changing over from the non-braking mode to the braking mode.

FIG. 2 represents again such a hydrodynamic retarder 3 with a rotor 5 and a stator 6. The rotor 5 can be decoupled again by means of a separating clutch 7 from a drive train which should be decelerated by the hydrodynamic retarder 3. The working medium is conveyed to the working chamber 10 of the hydrodynamic retarder from an external working medium circuit (not represented) via the inlet 11 and discharged via the outlet 12, so that the working medium can be cooled in the external working medium circuit. The working medium is fed by way of example, as represented, via a ring channel revolving over the periphery and further over one or several bores in the stator. The discharge can unfold accordingly, but only vice versa in the sequence of circulation.

In addition to the discharge 12, a pressure connection 13 for working medium coming from the working chamber 10 is provided on the hydrodynamic retarder 3, via which pressurised working medium can be guided into a pressure storage device 14 in the braking mode of the hydrodynamic retarder 3. To do so, a valve 15, in particular a check valve can be provided for regulating the charging of the pressure storage device 14.

The pressure storage device 14 moreover includes a pressure relief 16, usually with a valve 17, which guides pressurised working medium, in particular via the nozzle 18 represented here, for accelerating the rotor 5, to a back-mounted blading 19 of the rotor 5.

Consequently, even the energy produced by the retarder 3 itself can be employed later for accelerating the rotor 5, by way of example to synchronise the separating clutch 7.

1-11. (canceled)

12. A hydrodynamic retarder comprising:
a rotor rotating in a braking mode and a counter-rotor rotating for that purpose in opposite direction or a stationary stator, which together form a working chamber which is filled or can be filled with a working medium, wherein the rotor can be driven by the drive power via a drive train for braking the drive train;
wherein an energy storage device is associated with the retarder or is integrated therein, comprising a mechanical energy storage device, a pressure storage device or a kinetic energy storage device and an acceleration device connected to the rotor, wherein the acceleration device is connected to the energy storage device and the rotor or is integrated therein for transforming the energy stored in the energy storage device into an angular acceleration of the rotor.

13. The hydrodynamic retarder of claim 12, wherein the acceleration device is designed as a hydraulic machine, in particular as a piston engine or turbine, such as a Pelton turbine.

14. The hydrodynamic retarder of claim 12, wherein the acceleration device can be operated reversibly for feeding energy into the energy storage device and is in particular designed as a piston engine or a flow compressor.

15. The hydrodynamic retarder of claim 13, wherein the acceleration device can be operated reversibly for feeding energy into the energy storage device and is in particular designed as a piston engine or a flow compressor.

16. The hydrodynamic retarder of claim 12, wherein the energy storage device moreover comprises a loading device which stores kinetic energy in particular exclusively in a braking mode of the hydrodynamic retarder, in particular of the rotor of the hydrodynamic retarder and/or stores pressure energy of the working medium of the hydrodynamic retarder in the energy store.

17. The hydrodynamic retarder of claim 13, wherein the energy storage device moreover comprises a loading device which stores kinetic energy in particular exclusively in a braking mode of the hydrodynamic retarder, in particular of the rotor of the hydrodynamic retarder and/or stores pressure energy of the working medium of the hydrodynamic retarder in the energy store.

18. The hydrodynamic retarder of claim 12, wherein the energy store is designed as a flywheel which can be brought in driving connection with the rotor of the hydrodynamic retarder in a connectible fashion by means of a coupling, in particular a magnetic coupling.

19. The hydrodynamic retarder of claim 13, wherein the energy store is designed as a flywheel which can be brought in driving connection with the rotor of the hydrodynamic retarder in a connectible fashion by means of a coupling, in particular a magnetic coupling.

20. The hydrodynamic retarder of claim 14, wherein the energy store is designed as a flywheel which can be brought in driving connection with the rotor of the hydrodynamic retarder in a connectible fashion by means of a coupling, in particular a magnetic coupling.

21. The hydrodynamic retarder of claim 15, wherein the energy store is designed as a flywheel which can be brought in driving connection with the rotor of the hydrodynamic retarder in a connectible fashion by means of a coupling, in particular a magnetic coupling.

22. The hydrodynamic retarder of claim 16, wherein the energy store is designed as a flywheel which can be brought in driving connection with the rotor of the hydrodynamic retarder in a connectible fashion by means of a coupling, in particular a magnetic coupling.

23. The hydrodynamic retarder of claim 17, wherein the energy store is designed as a flywheel which can be brought in driving connection with the rotor of the hydrodynamic retarder in a connectible fashion by means of a coupling, in particular a magnetic coupling.

24. The hydrodynamic retarder of claim 12, wherein the energy store is designed as a pressure storage device or a spring mechanism and the acceleration device comprises a device for converting a translation into a rotation, in particular a piston thread rod, which carries the rotor, or a piston gear rack, which meshes with a gear in driving connection with the rotor.

25. The hydrodynamic retarder of claim 13, wherein the energy store is designed as a pressure storage device or a spring mechanism and the acceleration device comprises a device for converting a translation into a rotation, in particular a piston thread rod, which carries the rotor, or a piston gear rack, which meshes with a gear in driving connection with the rotor.

26. The hydrodynamic retarder of claim 14, wherein the energy store is designed as a pressure storage device or a spring mechanism and the acceleration device comprises a device for converting a translation into a rotation, in particular a piston thread rod, which carries the rotor, or a piston gear rack, which meshes with a gear in driving connection with the rotor.

27. The hydrodynamic retarder of claim 12, wherein a separating coupling is associated with the hydrodynamic retarder for mechanical decoupling of the rotor, and the acceleration device is arranged for partial or complete synchronisation of the separating clutch by accelerating the rotor when closing the separating clutch, which can be automatic or operated by a retarder control device actuating the retarder.

28. The hydrodynamic retarder of claim 12, wherein the energy store is designed as an air pressure storage device or a gas pressure storage device and the acceleration device is designed as an air motor, a gas motor, an air turbine, a gas pressure-operated turbine or gas turbine.

29. The hydrodynamic retarder of claim 12, wherein the hydrodynamic retarder is actuated such that during the changeover from a non-braking mode of the hydrodynamic retarder to the braking mode of the hydrodynamic retarder, in the braking mode and/or in the non-braking mode the rotor is accelerated with energy from the energy store by means of the acceleration device.

30. The hydrodynamic retarder of claim 29, wherein exclusively during the changeover of the retarder from a non-braking mode to a braking mode the rotor is accelerated with energy from the energy store by means of the acceleration device, and thereafter in the braking mode the rotor is exclusively driven with the driving power from a drive train, in particular a motor vehicle drive train for decelerating the drive train, in particular the motor vehicle.

31. The hydrodynamic retarder of claim 29, wherein the energy store is charged in the braking mode of the hydrodynamic retarder by means of kinetic energy of the retarder or pressure energy of the retarder, which in particular is provided or converted by the acceleration device or the charging device.
